(19) United States
(12) Patent Application Publication
(10) Pub. No.: US 2017/0306875 A1
(43) Pub. Date: Oct. 26, 2017

(54) METHOD OF FORMING A FUEL-AIR MIXTURE FOR INTERNAL COMBUSTION ENGINE

(71) Applicant: ASTROTANE, LLC, Attleboro, MA (US)

(72) Inventor: Alexander Vasilievich Schatalov, Shchyolkovo City (RU)

(21) Appl. No.: 15/373,060

(22) Filed: Dec. 8, 2016

(30) Foreign Application Priority Data
Apr. 25, 2016 (RU) 2016115942

(51) Int. Cl. F02D 41/14; F02M 31/18; F02D 41/00; F02M 25/025; F02M 25/10; F02M 31/20; F02M 27/04

(52) U.S. Cl. CPC F02D 41/1475; F02M 31/205; F02M 31/18; F02M 27/04; F02D 41/0027; F02M 25/025; F02M 25/10; F02D 41/1454

(57) ABSTRACT

A method of serially phased, phase forming a fuel-air mixture for internal combustion engine is disclosed. The technical result increases the compression ratio of the engine, resulting in economical fuel burning and improved environmental characteristics. The method includes a serially-staged, serially-phased formation of the fuel-air mixture for the engine, which includes the following steps: fuel evaporation; obtaining hydrogen-gas fuel by cleavage of the fuel; cooling and optimization of fuel temperature; preparation of air parallel to the preparation of the fuel; direct formation of the fuel-air mixture; mixing of the fuel, containing hydrocarbon gases with air, with an excess air coefficient Kea≧3; enrichment of the desired air-fuel ratio to the excess air coefficient Kea=from 1.0 to 2.8; a mixture enrichment correction; obtaining control conditions of an idling engine power mode by changing the excess air coefficient, as well as by changing the value of the cylinder filling coefficient.

### CROSS-REFERENCE TO RELATED APPLICATION

This patent documents claims priority to earlier filed Russian Patent Application No. 2016115942, filed on Apr. 25, 2016, the entire contents of which are incorporated herein by reference.

### BACKGROUND OF THE INVENTION

### 1. Field of the Invention

The invention generally relates to fuel delivery systems and method for combustion engines, and more specifically to gasoline feeding systems with pistons in internal combustion engines, rotary feeding systems and aircraft turbine engines—both, internal and external combustion engines, and others. It is mainly oriented for gasoline piston engines.

### 2. Background of the Related Art

Methods of forming the fuel-air mixture for the gasoline internal combustion engine such as an injection or carburetor, general and separate injection, direct electronic injection, combined with turbo-supercharging (TSI) are known generally.

In the carburetor process, fuel, gasoline, entrained with air flow in the injection device—carburetor, due to discharge produced by the engine cylinders. However, the injection process has always been unstable, especially at transitions from one mode to another mode. This process demanded continuous improvement of the carburetor, did not meet increasing environmental and economic requirements, and therefore gave way to electronic fuel injection systems.

Electronic fuel injection system are generally the best way to form a fuel-air mixture, thereby it better meets the modern requirements for gasoline engines.

Nevertheless, the development of engine-building, particularly gasoline engines, is limited emergence of such a phenomenon in engines as detonation and is solved, to a larger extent, not by the use of electronic systems, but by producing higher quality and therefore more expensive fuel, particularly gasoline. The sole purpose of these complex systems is to create the strictest conformity of gasoline and air. The power state control is carried out in the usual way—by changing the cylinder filling ratio.

There are also ways to enhance the efficiency and economy of internal combustion engines by preparing pre-fired fuel-air mixture due to hydrogen-contained gases and carbon monoxide, and adding these gases to the fuel-air mixture.

Thus, U.S. Pat. No. 4,147,142, published Apr. 3, 1979, proposed to produce evaporation and heating of the liquid-fuel, up to 200° C., by the heat of the exhaust gases from the heat exchanger, by adding them directly to the fuel-air mixture. The combustible mixture enters the chamber with a catalyst, in the presence of which a liquid-fuel splits to form gases.

For these purposes, to only use exhaust gas heat is insufficient, which may lead to an ineffective, unstable process run. Therefore, reaching a higher temperature is achieved by burning additional fuel, increasing the total flow of fuel.

The method discussed in U.S. Pat. No. 3,901,197, published on Aug. 26, 1975, provides for the separation of the normal fuel-air mixture, for combustion, into two streams. The first of them—the supportive, with less flow, burns completely through with an open flame as it passes through the heat exchanger. Second—the major stream, passes through the channels in the heat exchanger, heating it. Then, the second stream mixes with the hot gases of the first stream. The heated mixture is fed into a catalyst chamber with the catalyst, and then into the engine.

To use an open flame in this method is not only ineffective, but also dangerous. The danger increases with the irregular working condition of the engine and interruptions, since the rate of flame propagation of the fuel-air mixture may be greater than the velocity of the mixture itself. In addition, the rich mixture cannot burn without residue and therefore contains unburned hydrocarbons such as CnHn+₂, which in the form of soot/coke, is deposited in the pores of the catalyst, disabling it.

Therefore there is a perceived need for an improved method of forming the fuel-air mixture in an internal combustion engine that is more fuel efficient and cleaner burning.

### SUMMARY OF THE INVENTION

The technical result is the ability to increase the compression ratio of the internal combustion engine and, consequently, economical fuel burning and improved environmental characteristics, using various types fuels. The claimed result is achieved by method of serially-staged, serially-phased formation of the fuel-air mixture for the internal combustion engine, which includes the following steps: fuel evaporation; obtaining hydrogen-gas fuel by cleavage of the fuel; cooling and optimization of fuel temperature; preparation of air parallel to the preparation of the fuel; direct formation of the fuel-air mixture; mixing of the fuel, containing hydrocarbon gases with air, with an excess air coefficient Kea≧3; enrichment of the desired air-fuel ratio to the excess air coefficient Kea=from 1.0 to 2.8; a mixture enrichment correction; obtaining control conditions of an idling engine power mode by changing the excess air coefficient, as well as by changing the value of the cylinder filling coefficient.

### DETAILED DESCRIPTIOPN OF THE PREFERRED EMBODIMENTS

In the proposed method, the fuel-air mixture is formed gradually and in several stages.

In the first stage of the fuel preparation, the fuel is fed into the evaporator, where it expands during evaporation, which eliminates the use of additional aids for the movement of the fuel in the system. In the evaporator, heat can be used from either the exhaust gases, or from other sources, for example, the heat from the onboard electric-power supply.

In the second stage, fuel vapors enter into a special device, where they are exposed to factors capable of decomposition/separating the fuel. As a result, the hydrogen-containing gases are formed: H₂—hydrogen, CH₄—methane, C₂H₆—ethane, C₂H₄—ethylene, C₂H₂—acetylene, C₃H₈—propane, C₃H₆—propylene, i-C₄H₁₀-isobutene, n-C₄N₁₀-n/-butane and other derivatives of gaseous and liquid hydrocarbons in the percentage, contained in the fuel.

These factors include: thermal, dynamic, chemical, piezoelectric, of crown-discharged, electro-arced; it also includes diffuse plasma, ultrasound, cavitation, catalytic, and even nuclear—ways of fuel decomposition.

Selection of the above listed factors and their amounts depends on:
1. engine type: gasoline piston, gasoline rotary, diesel, gas turbine for aviation, gas turbine for land use, reactive, and others.
2. tasks performed by the engines: work in difficult urban environments, sports race, work in Arctic conditions, and others.

Selection of the factors affect:
1. -% formation and fractional composition of the hydrogen-containing gases.
2. the final octane number of the resulting mixture (the octane number is the degree of formation of the peroxide groups, which are the cause of the detonation. Reducing the magnitude of detonation, ultimately, increases the compression ratio.)
3. elimination of undesirable phenomena, such as formation of polymer compounds, coke and deposition of both polymer compounds and coke on the walls of the construction system
4. the rate of combustion of the mixture (the rate of flame propagation)
5. the completeness of fuel combustion
6. reducing the formation of harmful compounds such as CO, NO₃, and others, without the use of special filters—the exhaust gas neutralizers
7. the ability to support all of the above properties of the fuel under extremely low air temperatures and in a wide range of values of excess air coefficient Kea=from 1.0 to 2.80, which are important for aircraft engines.
8. possibility of using different types of liquid fuel and their mixtures (multifuel)
9. the elimination of differences between the requirements for the use of special fuels—summer-fuel, winter-fuel, arctic-fuel, on the basis of alcohol, etc.,

Because these effects are highly desirable and are one of the goals to achieve in this development, the proposed method involves the use of up to several factors capable of decomposing the fuel, acting on the fuel at the same time (parallel) or sequentially.

The next step in fuel preparation is cooling and temperature adjustment to avoid unintentional ignition when connecting with the air, as well as to create a stable and optimum temperatures of air-fuel mixture.

In parallel with the fuel preparation, air can be prepared, just like the fuel, in stages or simultaneously. The preparation of the air may include steps such as humidification, ozonation (ozone treatment), an air treatment with magnetic fields, such as HFC (high frequency current), the introduction of chemicals, such as oxidizing agents, or others—in the presence of which combustion processes give the best environmental effect.

After the completion of the preparation of the fuel and air, the first phase of the formation of direct air-fuel mixture (the fuel mixing) comes into action, with the content of hydrogen-containing gases, and the air with excess air coefficient Kea≧3.

The second phase is the re-enrichment of the fuel-air mixture to the desired excess air coefficient Kea. The desired excess air coefficient Kea depends on the regime of engine load at a particular time and is determined by the electronic system of the engine.

Since the resulting fuel mixture has high anti-knock properties and is able to burn well in a fairly wide range of excess air coefficient values Kea, the observed method regulates the load on the engine using not only the fullness of the cylinder, but also by changing the excess air coefficient of Kea in the broad range from 1.0 to 2.8.

In connection with this, the proposed method provides another phase, or more additional phases—which correct and re-enrich the mixture.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

1. A method of formation of a fuel-air mixture for internal combustion engine, comprising:
evaporating fuel;
decomposing the fuel;
obtaining the hydrogen-containing gases from the fuel;
cooling and optimization of the temperature of the fuel;
preparation of air for mixture with the fuel;
mixing the fuel and air to form a fuel-air mixture; and
re-enrichment of the air-fuel mixture to the desired excess air coefficient.

2. The method of claim 1, further comprising correcting the mixture enrichment.

3. The method of claim 1, wherein the air preparation occurs in parallel with the fuel preparation.

4. The method of claim 1, wherein the mixing of the fuel containing hydrocarbon gases, with air with the excess air coefficient Kea≧[[4]]3.

5. The method of claim 1, wherein the excess air coefficient Kea=from 1.0 to 2.8.

6. The method of claim 1, wherein the preparation of the air is selected from the group consisting of humidification, ozonization, treatment with magnetic fields, and chemical treatment.

7. The method of claim 1, further comprising obtaining control conditions of an idling engine power mode by changing the excess air coefficient, as well as by changing the value of a cylinder filling coefficient.

8. The method of claim 1, wherein the step of evaporating the fuel comprises applying heat to the fuel.

9. A method of formation of a fuel-air mixture for internal combustion engine, comprising:
evaporating fuel through heating of the fuel;
obtaining the hydrogen-containing gases from the fuel;
cooling and optimization of the temperature of the fuel;
preparation of air for mixture in parallel with the fuel;
mixing the fuel and air to form a fuel-air mixture; and
re-enrichment of the air-fuel mixture to the desired excess air coefficient; and
correcting the mixture enrichment.

10. The method of claim 9, wherein the mixing of the fuel containing hydrocarbon gases, with air with the excess air coefficient Kea≧[[4]]3.

11. The method of claim 9, wherein the excess air coefficient Kea=from 1.0 to 2.8.

12. The method of claim 9, wherein the preparation of the air is selected from the group consisting of humidification, ozonization, treatment with magnetic fields, and chemical treatment.

13. The method of claim 9, further comprising obtaining control conditions of an idling engine power mode by changing the excess air coefficient, as well as by changing the value of a cylinder filling coefficient.
